(19) United States
(12) Patent Application Publication
(10) Pub. No.: US 2005/0015340 A1
(43) Pub. Date: Jan. 20, 2005

(54) Method and apparatus for supporting service enablers via service request handholding

(75) Inventor: Stephane H. Maes, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Oracle International Corporation, Redwood City, CA (US)

(21) Appl. No.: 10/855,999

(22) Filed: May 28, 2004

Related U.S. Application Data
(60) Provisional application No. 60/483,292, filed on Jun. 27, 2003.

(51) Int. Cl. G06F 17/60

(52) U.S. Cl. 705/44

(57) ABSTRACT

A system for enforcing an execution policy associated with a responder includes a framework configured to enforce the execution policy of a target responder in response to a request from a requester, wherein the framework is configured to intercept a request to the target responder, wherein the framework is configured to call at least one supporting finction specified by the execution policy, and wherein the framework is configured to pass the request to the target responder after the call to the one supporting function is successful.

### CROSS-REFERENCE TO RELATED APPLICATIONS

The present invention is related to and incorporated by reference for all purposes the following pending provisional patent application: “Method and Apparatus for Supporting Service Enablers via Service Request Handholding”, U.S. application Ser. No. 60/483,292, filed Jun. 30, 2003.

### BACKGROUND OF THE INVENTION

The present invention generally relates to web services. More particularly, the present invention relates to supporting requests for services or enablers by composing additional supporting requests for web services.

Different approaches have been introduced to specify guidelines for interoperability of services and service enablers. Such approaches have included Web Services, java beans, portlets, CORBA/IIOP, and others. These approaches require that developers specifically provide particular function calls for services and service enablers. Further, these approaches require the developers to create and support virtually all of the additional services (“support functions”) for such services. Because of this, there is often little incentive for developers to develop supporting functions that could be used by other developers. Accordingly, few, if any, situations are envisioned where services and service enablers from independently developed providers can be used together at run-time.

Current approaches to interoperability include Parlay (http://www.parlay.org), and Web Service technologies including WSFL, WSXL, UDDI, OASIS WS inspection, OASIS WS-Security, WS-Provisioning, SLA, Liberty (http://www.projectliberty.org.), and others. These approaches specify guidelines for supporting functions, however they do not specify any mechanism on how supporting functions can systematically be used or enforced. More particularly, the inventor of the present invention has determined that these services do not contemplate independent service function composition, combination, aggregation, or coordination in any way that would allow a service provider to control and manage efficiently the way that it exposes its enablers or services to other parties in automatable ways, where the requestor can determine the conditions that it must satisfy to access and use the enabler or the services and can satisfy them. Further, the existing services do not contemplate the service provider validating that these conditions as well as any additional conditions internally imposed and not exposed to the requester, have been satisfied. The inventor has determined that typically, such conditions amount to specifying what are the supporting functions that must be called, for example for authentication, authorization, charging, or logging—only authentication is exposed and the conditions presented to the requestor allow the requester to provide the appropriate credential (e.g. user ID and password or digital certificate). Further it allows the requester to provide the credentials in the right format (e.g. digital certificate, compression). These conditions will be referred to herein as execution policies.

As an example, the Parlay framework specifies a centralized framework for discovering and supporting service enablers. Upon authentication of a requester, a service enabler is instantiated and made available to the requestor. However, the framework was developed prior to and independently from web services and therefore it does not, for example, cater for providing the Parlay framework functionality to generic web services. The Parlay framework is fundamentally a session-based approach where services are instantiated upon request and then protected by hiding its address for the duration of the instantiation. This, and a Corba architecture, are not a recommended solution for distributed deployment across different domains. Further, Parlay requires skilled developers to use an IIOP framework or a CORBA architecture (even when on top of HTTP or using SOAP) and develop appropriate interfaces for each service enabler or service. Composing such interfaces is not simple, thus the adoption of this approach for determining the availability and the enforceability of supporting functions is limited.

Additionally, the Parlay framework does not appear conducive to distribute deployments over a network, such as the public internet, based on Web Services. More specifically, the Parlay Web Services Framework (authentication, authorization and SLA (Service Level Agreement) ) is based upon instantiation of known services, and not upon discovery and use of new enablers or services.

In light of the above, what is desired is a new common framework without the drawbacks described above.

### BRIEF SUMMARY OF THE INVENTION

Embodiments of the present invention relate to services. More particularly, the present invention relates to supporting managed and controlled exposure of enablers or services in a manner that conditions can be enforced and validated possibly in an automatable manner and conditions relevant to the requestor can be discovered also in a automatable manner so that the responder can pass the necessary information. It also relates to providing simple ways to manage the delegation of tasks to other functions available to perform such tasks instead of having to implement these tasks within each enabler or services. Further, the present invention relates to a new common framework for secure support of mobile service enablers that relies on supporting functions and hand holding, and that in the case of web services is interoperable with web service security, provisioning, and identity management.

The inventor has provided a framework for allowing a service provider to control and efficiently manage the way that it exposes its enablers or services to other parties in automatable methods. For example methods are provided for enabling a requestor to determine conditions that it must satisfy to access and use the enabler or services, methods for enabling them to satisfy the conditions, and methods for enabling a service provider to validate that these conditions as well as any additional conditions internally imposed and not exposed to the requestor, have been satisfied. Such conditions amount to specifying what are the supporting functions that must be called (e.g. authentication, authorization, charging, logging—only authentication-is exposed in the conditions presented to the requestor to allow to provide the appropriate credentials (e.g. user ID and password or digital certificate) in the right format (what digital certificate, what compression). These conditions will be referred to as execution policies herein. An additional feature of the invention is that a provider can easily 1) manage (check, debug, test, update, change, . . . ) the execution policies that must be enforced 2) deploy them across its domain for existing or new enablers or services.

Embodiments of the present invention disclose a simple mechanism in conjunction with the above-cited patent application. Specifically, embodiments disclose enablers registering their capability and execution policies with a framework. Discovery requests for particular enablers return pointers to the enabler along with execution policies associated to the enabler. The framework enforces the execution policies by acting on any request. The embodiments also allow requesters to select desired service enablers, typically on a step by step basis. Discovery and other requests can be associated with additional execution policies issued by the requestor that the handholding mechanism should also satisfy. The framework management and enforcement of the execution policies define the handholding mechanisms.

In the present embodiment, the handholding framework includes an execution policy management and possibly a negotiation mechanism, and an execution model environment that enforces the execution policy associated to each request and answer. In the present embodiment, the handholding framework should specify a list of capabilities and functions as described in the above-cited patent application. In addition, any additional enabler authorized by the framework execution policies, can be used as basic handholding framework capabilities if it allows it in its execution policies, and as enabler accessible through the handholding framework.

Embodiments of the present handholding framework may be distributed or shared across different nodes. Further, some handholding framework functions can be performed on the application side, the enabler side or the discovery enabler side. Additionally, handholding framework nodes may be transparent. End Points are enablers (including directory), application/services. In the present embodiment, some framework nodes can sometimes be “viewed” as container/execution environments for the enabler (including directory) and application/requestor.

In the present embodiment, basic framework functions/capabilities may exist on all framework nodes and may be standardized. Such basic framework functions typically require separate enablers (e.g. Authentication Enabler, Charging/Billing Enabler) as well as other “proprietary” functions. In various embodiments, framework functions can be bound to particular nodes as particular deployment cases that can be linked to specific use cases, market needs or product/deployment optimization.

In the embodiments illustrated below, a single handholding framework is illustrated. However, it should be understood that it is merely a symbolic representation of the logical mechanisms, and a network of frameworks may be actually used. A requestor does not need to be aware or even know the presence or address of the components that implement the framework mechanisms in the present embodiment (but it may be aware or knowledgeable of it). In general, it will be assumed that this is achieved by ensuring that the discovery result points to the enabler through the necessary framework functions. In one example a transparent proxy function or URI re-direction captures URI-based requests of enablers and re-directs then as specified by the execution policy. In cases where this is not supported, the same result can be achieved by ensuring that discovery of enablers return composed enablers that pre-impose the active policies or that the discovered URI is actually the framework address that then on the fly re-directs or behave as a new enabler that performs all the execution policy steps before executing the request. Such embodiments may require that a requestor provide access to its own policies when issuing a discovery request, for example, in order to allow selection of the steps: at discovery or as a negotiation of policies: e.g. what authentication provider would the user want to use—can the service provider accept an authentication token from it etc.

In other embodiments, messages can be pushed or initiated by an enabler towards an application or “requester,” as well as in between enablers. In such a case, the enabler that initiates the request plays the role of the requestor and reaches its target with a similar flow involving similar mechanisms and using a same or different instance of the framework mechanism. This case also covers responses to requests made to a responder.

In other embodiments, enablers coordinate through framework mechanisms. In particular, different directory enablers can replicate, synchronize or coordinate their information when appropriately authorized and within the limit of privacy policies etc. Such embodiments may use schemes similar to WSXL (for the particular embodiment of a web services).

According to one aspect of the invention, a method for a requester device is described. The method may include receiving a request to perform a service, sending a message to a discovery enabler to request the service, receiving from a framework an indication that a first prerequisite service needs to be performed, and determining a first enabler to perform the first prerequisite service. Various techniques may include composing a first service request to the first enabler, and submitting the first service request to the first enabler. Thereafter, the technique includes receiving from the framework an indication that the service can be performed, composing a request for the service to a target enabler, and submitting the request to the target enabler. At the logical level, in one case a request is intercepted re-directed or passed to the different enablers/functions as specified by the logic of the execution policies until it can eventually reach the target enabler. The same may be true on the response if requested by the policies.

According to another aspect of the invention, a method for a handholding framework is described. The method may include receiving a request from a requester for a target service, receiving a target service execution policy from a directory enabler, in response to the request. This may also be obtained in other ways, such as storing the execution policy at registration or at discovery and requesting it when a request is made. It can then be the object of implementation optimizations whereby for example, the execution policy for a responder is cached and when a request comes in, the framework checks if the policy has changed or not. Additional steps may include providing an indication of a first prerequisite service to the requester in response to the target service execution policy. The technique may include receiving a composed service request from the requester for a first service enabler, receiving a response from the first service enabler in response to the composed service request, and determining whether the first prerequisite service of the target service execution policy is satisfied by the response from the first service enabler. When all prerequisite services of the target service execution policy are satisfied, the technique include providing an indication of the target service to the requester. The process may be iterated as required by the execution policy until all steps are satisfied.

According to yet another aspect of the invention, a computer system is described. The apparatus may include a memory configured to store specifications of a plurality of target service enablers, configured to store specifications of a plurality of support service enablers, and configured to store a plurality of execution policies for the plurality of target service enablers the descriptions of the interface of the available responders. Each execution policy is typically configured to specify support services (or other calls even to proprietary functions) that are prerequisites to respective target services. The system may also include a processor coupled to the memory, wherein the processor is configured to receive a request for a service from a user at a remote device, and wherein the processor is configured to determine a target service enabler from the plurality of target service enablers to provide the service. The processor may also be configured to determine an execution policy of the target service enabler from the plurality of execution policies (e.g. by querying the request/discovery enabler to obtain the policy, or as discussed above, based on an optimization scheme. -Typically the processor is configured to request/determine the execution policy of the target service enabler to a handholding framework. In this system, the handholding framework specifies to the requester support services that are prerequisite to the service, and the handholding framework verifies that the support services that are prerequisites to the service are satisfied on a step by step basis, before the request for the service is provided to a target enabler. Additionally, the handholding framework may also specify meta-data and additional interface aspects that the requestor must provide when making a request to the target enabler so that the policy may be satisfied. (e.g. authentication credential: which one, what format, etc.). Other execution policy items (e.g. charging terms, logging, . . . ) may not be provided to the requester but may be known by the framework that enforces the policy on the request.

According to another aspect of the invention, a system for enforcing an execution policy associated with a responder includes a framework configured to enforce the execution policy of a target responder in response to a request from a requester, wherein the framework is configured to intercept a request to the target responder. The framework is configured to call at least one supporting function specified by the execution policy, and the framework is configured to pass the request to the target responder after the call to the one supporting function is successful.

According to yet another aspect of the invention, a method is described. The technique may include intercepting in a framework, a request to a target responder, and calling from the framework, at least one supporting function specified by an execution policy associated with the target responder. The techniques may also include determining in the framework, whether the one supporting function has successfully completed, and passing from the framework, the request to the target responder after the one supporting function has successfully completed.

In one embodiment, the framework processes any message exchange between components of the system in order to determine what execution policy must be enforced. Additionally, the framework must validate that the enforcement was successfully performed before letting a message reach its target. Additionally, any actor (requester/responder) may be associated with such execution policies to enforce on any message exchange to and from it.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1 illustrates an overview diagram of an embodiment of the present invention;

FIG. 2 is a block diagram of a system according to an embodiment of the present invention;

FIGS. 3A-C illustrate an overview diagram according to an embodiment of the present invention; and

FIG. 4 illustrates another embodiment of the present invention.

### DETAILED DESCRIPTION OF THE INVENTION

The following definitions are used herein.

Conditions are called execution policies and they are defined as: Execution Policies: The expression of a set of conditions that must be enforced (executed and validated) on any request or exchange that takes place. These conditions involve policy assertions and logic expression between policy assertions.

Policy assertions: An individual preference, requirement, capability or other property that can be evaluated or executed.

Policies: A definite goal, course or method of action to guide and determine present and future decisions. “Policies” are implemented or executed within a particular context. Such a rule is supposed to be used for receiving a set of parameters and producing a result. A static policy is a particular case of policy assertions that must be evaluated.

Policy Workflows: The expression of a series of assertions that must be executed. Workflows are particular cases of execution policies where the logic expressions describe sequences in which assertions must be executed.

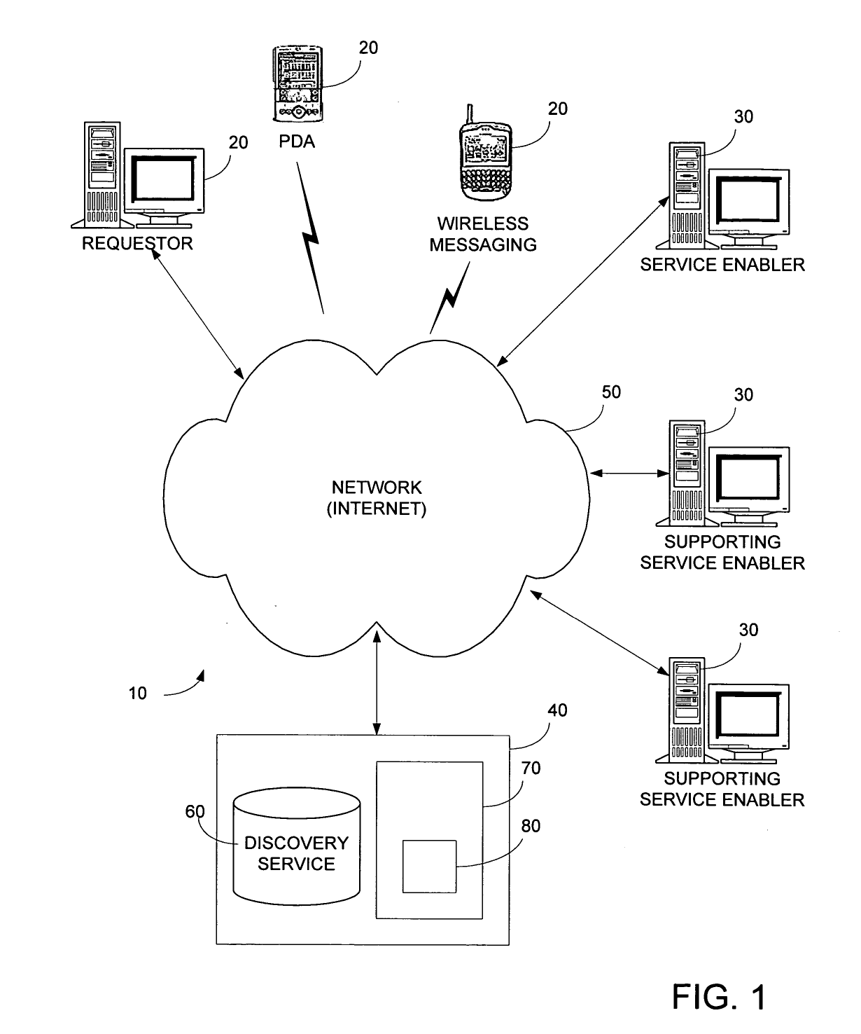

FIG. 1 illustrates an overview diagram of an embodiment of the present invention. In FIG. 1, a network 10 is illustrated including a number of requestors 20, a number of service providers 30, and a logical framework 40 mechanism that enforces execution policies of the target service provider. Requestor 20, service providers (service enablers) 30, and logical framework 40 may be coupled via a network 50 either via cables, wires and/or wirelessly and can be within same or across different domains. In this embodiment, requestors 20 are not limited to a wireless device and can be another service or enabler located in the network (within the domain of the service provider) or in other domain.

In one embodiment, network 50 may be a wide-area-network such as the Internet, whereas in another embodiment, network may be any other network, such as a virtual private network, a local area network, or the like.

In the present embodiment, requestors 20 may be any requester or device, such as another computer, a conventional wireless device, such as a PDA, a mobile telephone, a wireless e-mail device (e.g. a “blackberry”), a pager, or the like. In other embodiments, requestors 20 may also include laptop computers or desktop computers coupled to network 50. In still other embodiments, devices 20 may be, but is not limited to be any conventional client system.

As will be described further below, in one embodiment, service providers 30 typically provides a services for requestors 20. In this example, service providers 30 are also termed “service enablers.” [Typically, no service provider expose services or service enablers.] As examples, service enablers 30 may enable services such as user authentication services, user authorization services, user accounting and billing services, user personalization services, and the like.

In one embodiment, service providers 30 may be embodied as a traditional web server coupled via wires to network 50. In other embodiments of the present invention, service providers 30 may be embodied as any system that provides services to requestors (e.g. wireless devices) 20.

In the present embodiment, Framework 40 includes two portions, a discovery portion 60 and a policy enforcement portion 70 that include execution of the different steps of the execution policies and validation of the results. As will be discussed further below, discovery portion 60 provides requestor 20 selections of services that are exposed through framework 40. In this example, policy enforcement portion 70 includes a listing of policies desired or required to be executed by services listed in discovery portion 60. These policies may be acquired from the directory, as discussed above, in numerous ways including at registration (and caching), at discovery (and caching) or at the moment of the request. Embodiments of the two first cases include the possibility of checking at enforcement time, whether the policy has changed or not.

In one embodiment, the discovery step is handled in the same manner in the industry for Web Services, i.e. the service provider registers its enabler/service with its policy. The discovery step can be done in many different ways, including: automatically (e.g. using UDDI) or out of band, because the address, interface and associated relevant policy assertions have been passed in another channel (e.g. including in a paper document). In this embodiment, whatever is passed is the composed enabler that matches the policies.

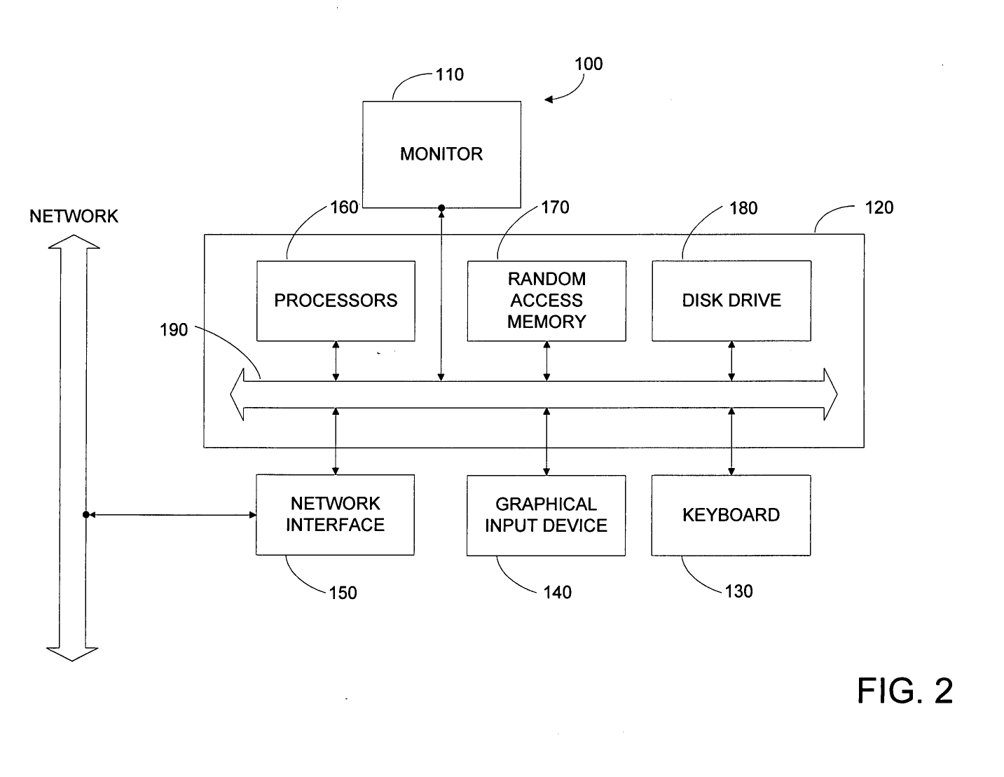

FIG. 2 is a block diagram of typical requestor 20 according to an embodiment of the present invention. In the present embodiment, computer system 100 typically includes a monitor 110, computer 120, a keyboard 130, a user input device 140, a network interface 150, and the like.

In the present embodiment, user input device 140 is typically embodied as a computer mouse, a trackball, a track pad, wireless remote, and the like. User input device 140 typically allows a user to select objects, icons, text and the like that appear on the monitor 110.

Embodiments of network interface 150 typically include an Ethernet card, a modem (telephone, satellite, cable, ISDN), (asynchronous) digital subscriber line (DSL) unit, and the like. Network interface 150 are typically coupled to a computer network as shown. In other embodiments, network interface 150 may be physically integrated on the motherboard of computer 120, may be a software program, such as soft DSL, or the like.

Computer 120 typically includes familiar computer components such as a processor 160, and memory storage devices, such as a random access memory (RAM) 170, disk drives 180, and system bus 190 interconnecting the above components.

In one embodiment, computer 120 is a PC compatible computer having multiple microprocessors such as Xeon™ microprocessor from Intel Corporation. Further, in the present embodiment, computer 120 typically includes a UNIX-based operating system.

RAM 170 and disk drive 180 are examples of tangible media for storage of data, including computer programs, applet interpreters or compilers, virtual machines, embodiments of the herein described invention including service policies, a composition enabler engine, a specification of web services supported, the herein described framework, portions of the framework, and respective service enablers, and the like. Other types of tangible media include floppy disks, removable hard disks, optical storage media such as CD-ROMS and bar codes, semiconductor memories such as flash memories, read-only-memories (ROMS), battery-backed volatile memories, networked storage devices, and the like.

In the present embodiment, computer system 100 may also include software that enables communications over a network such as the HTTP, TCP/IP, RTP/RTSP protocols, and the like. In alternative embodiments of the present invention, other communications software and transfer protocols may also be used, for example IPX, UDP or the like.

FIG. 2 is representative of computer rendering systems capable of embodying the present invention. It will be readily apparent to one of ordinary skill in the art that many other hardware and software configurations are suitable for use with the present invention. For example, the use of other micro processors are contemplated, such as Pentium™ or Itanium™ microprocessors; Opteron™ or AthlonXP™ microprocessors from Advanced Micro Devices, Inc; PowerPC G3™, G4™ microprocessors from Motorola, Inc.; and the like. Further, other types of operating systems are contemplated, such as Windows® operating system such as WindowsXP®, WindowsNT®, or the like from Microsoft Corporation, Solaris from Sun Microsystems, LINUX, UNIX, MAC OS from Apple Computer Corporation, and the like.

In one embodiment, computer system 100 includes a computer program that is possible part of another application, that allows computer system 100 to serves as a requestor.

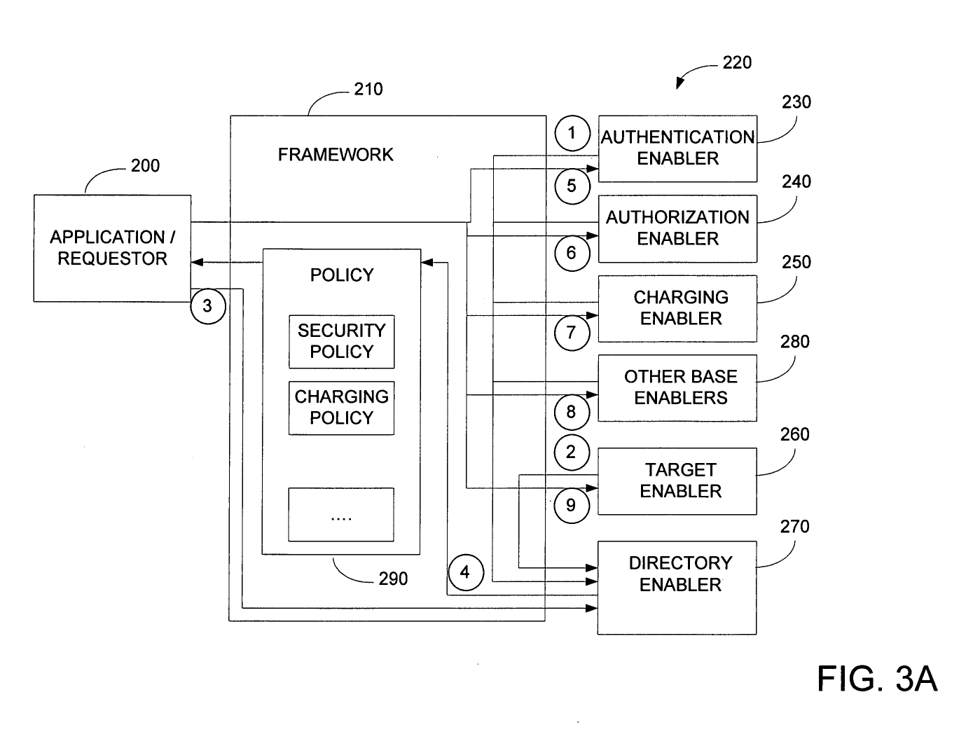

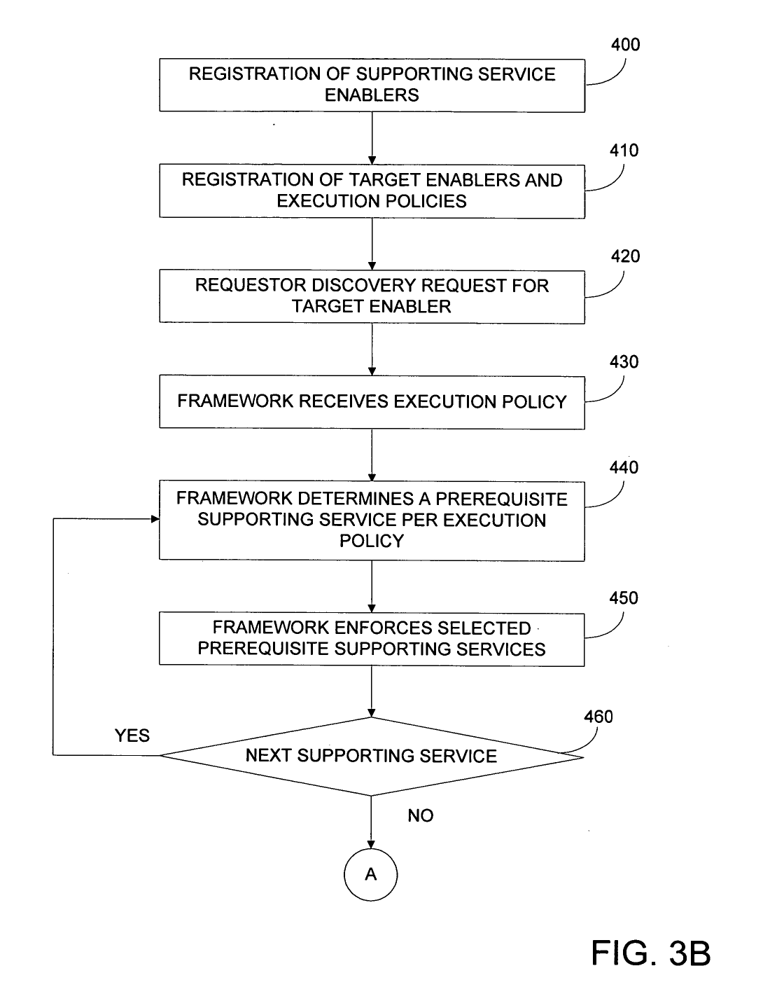

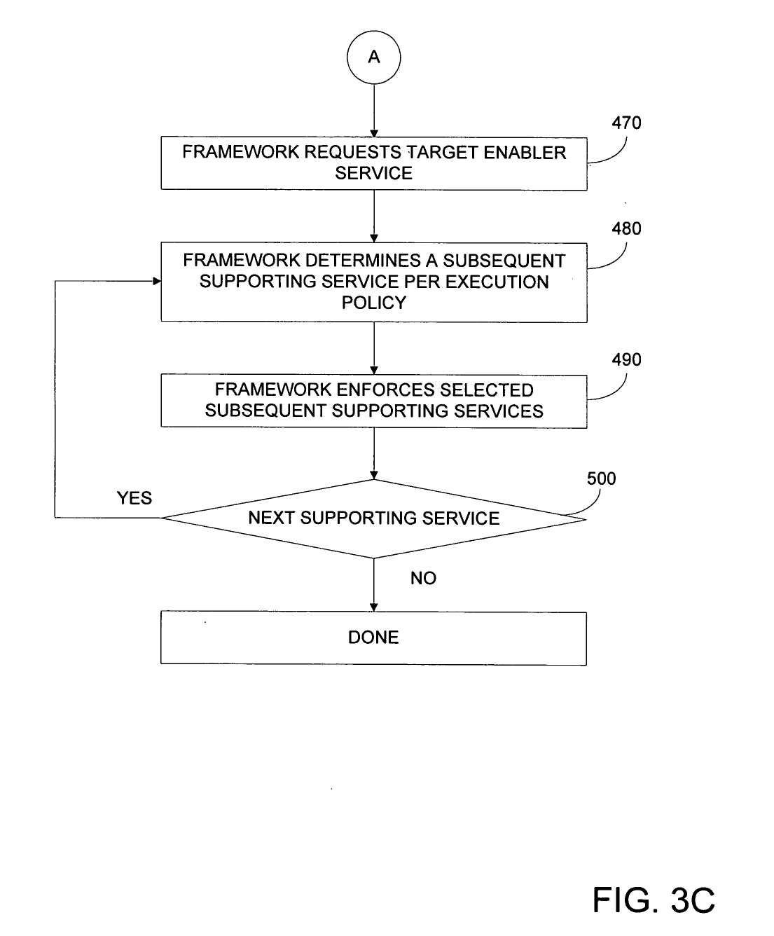

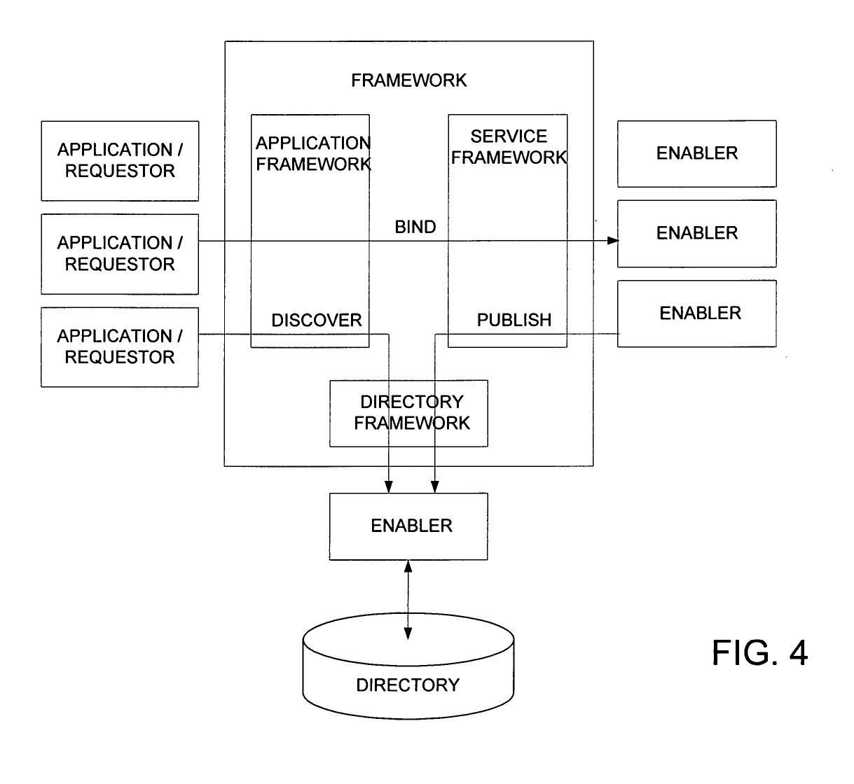

FIGS. 3A-C illustrate an overview diagram according to an embodiment of the present invention. FIG. 3A includes a requester 200, a framework 210, and a number of enablers 220. In this example, enablers 220 include an authentication enabler 230, an authorization enabler 240, a charging enabler 250, a target enabler 260, and a directory enabler 270. Additional enablers may be included and are represented as enabler 280. As will be described further below, directory enabler 270 provides a policy 290 to framework 210.

In this embodiment, security/charging policies etc are assertions or sets of assertions related to each of the different enablers, that are to be called as prescribed by the execution policy. The policy is obtained in band (for example as a binding to the interface descriptor obtained from the directory at discovery) or out of band. Additionally, in the various embodiments, each enabler and supporting function may itself have its own execution policies. Then for each request or response to each of them the same process must be repeated (i.e. the corresponding execution policy must be enforced and validated before being passed to the target responder).

An overview of the process in FIGS. 3A-C includes enablers 220 such as enablers providing “supporting services” such as enablers 230, 240, 250, and 280 registering their capabilities along with their own execution policies, with discovery enabler 270, step 400. Next, target enabler 260 and associated execution policies 290 register with discovery enabler 270, step 410. Subsequently, requestor 200 sends a request for services to discovery enabler 270, step 420. In response, discovery enabler 270 identifies target enabler 260, and provides execution policies 290 to framework 210, step 430. Other techniques for getting the execution policies are contemplated in other embodiments.

In the present embodiment, the requester receives a filtered version of the execution policy that describes the meta-data/policy assertion for information (e.g. authentication credentials) that it must provide with its request in response to execution policies 290. When a request is received, framework 210 generates a number of services requests according to execution policies 290 to enablers 230, 240, 250, and 280. In one embodiment, execution policies 290 do not specify specific enablers 230, 240, 250, and 280, but only specify that particular supporting services be performed. Accordingly, framework 210 will receive a pre-requisite supporting service per execution policy 290, and in response framework 210 will determine an appropriate service enabler to satisfy that supporting step, 440. It is possible that some of the requesters are authorized to propose preference in terms of what enabler/who performs some of the steps. In such a case, the requester may be able to examine these steps in the filtered policy that it receives. Additionally, the requester may be able to provide information resulting from prior steps (e.g. authentication token received earlier), negotiate who should do some steps if acceptable. It may do this by providing its own preferences to the framework prior to the request or bound to the request or by performing some of the steps itself and return the result with the request. For example, an authentication step may be performed by the requester by calling an authentication provider (acceptable according to the policies) and providing the resulting token included with the request.

In this embodiment, next, the request is intercepted by framework mechanism 40 as is any request/exchange across the system. The framework 40 then determines the execution policy and executes the different steps. This is also not only a composition of calls but a sequence of calls. Accordingly, framework 40 awaits for results before passing to the next one, etc until the prerequisites for the execution policy have been successfully satisfied. This process typically repeats, step 460, until all of the prerequisite supporting services specified by execution policies 290 are satisfied. In some embodiments, some a priori steps, such as steps 440-460 may not be performed. For example, such steps may be done by the requester (e.g. to satisfy a policy with a preferred provider). This step-by-step execution of execution policies 290 illustrate the “handholding” aspect of an embodiment of the present invention, as enforced by the policy by framework 40.

In the present embodiments, each of the steps driven from framework 40 may result into exchanges between the supporting service and the requestor (e.g. prompting for user id and password if it was not passed originally) this may help in cases where the requester can not understand the passed policies and can allow not to have to update the interface descriptor to reflect that such information must be passed.

When the prerequisite supporting services of execution policies 290 have been satisfied, requester 200 typically composes the service request to target enabler 260, step 470. The response from target enabler 260 (or a push initiated by such an enabler) can be further processed, as specified by execution policies 290, when trying to reach an application or requester; or another enabler. Steps 480-500 may then be performed per execution policies 290, after the service has been provided. These step-by-step execution of execution policies 290 again illustrate the “handholding” aspect of an embodiment of the present invention. A more detailed description of aspects of the present embodiment are given below.

Execution Policies:

In embodiments of the present embodiment, other instances of the framework mechanism may be created, and the framework functions can be shared across multiple nodes. Current embodiments of discovery enablers 270 may use UDDI and WS-Inspection with directories with well known addresses, and static discovery at authoring or deployment. Additional embodiments may include dynamic registration and discovery of the enablers, and distribution of the directory enabler capabilities. Dynamic discovery and registration embodiments are particularly useful for mobile and roaming and mobile deployments across different access mechanisms and access network providers. Again, the discovery step can be done in many different ways, including: in-band, automatically (e.g. using UDDI) or out of band, because the address, interface and associated relevant policy assertions have been passed in another channel (e.g. including in a paper document).

In embodiments of the present embodiment, execution policies and WS-execution policies guide the appropriate actors (discovery enabler, target enabler, requestor, and the like) in execution of rules and preferences: An enabler can describe its framework capabilities (or others), can describe prerequisite enablers and subsequent enablers that should be called. Additionally, requestors can describe its own preferred or required settings and user-determined settings. In this embodiment, a requestor can describe similar policies when it is contacted by another requester. Additionally, a requester can specify preferences or requirements such as which capabilities should be requested, and how the capabilities are requested (e.g. who can access what information and process it). Eventually, the service provider can establish generic policies that apply across all the enablers or services that it exposes on all traffic that crosses its network.

In the present embodiment, actors that control portions or instances of the framework can describe, the overall execution policies for accessing some or all enablers, such as policy 290, above. For example, the policy may specify authentication, authorization, charging and filtering/privacy protection supporting service enablers to be performed. In the example in FIG. 3A, above, directory enabler 270 provides policies for direct coordination or interaction with other enablers. This is especially important when a local directory is used across different access mechanisms or access network providers.

In web service embodiments of the present invention, the handholding framework described, typically defines WS-Execution Policies including execution policy formats, execution policy exchanges and integration with discovery, execution policy negotiation, execution policy enforcement and the like.

Enabler and Policy Registration:

In the present embodiment, supporting service enablers and target enablers specify their addresses, interfaces (capabilities), descriptions and the like. This may include enablers that implement the basic framework capabilities, and other enablers provided as third party enablers or variations of the basic framework enablers. In the present embodiment, this may include a specification of execution policies for target enablers and framework enablers that are bound to the interface description. As an example, a framework enabler may include an execution policy that specifies the enabler requirements for applications (e.g. X509 required for service).

Discovery

As illustrated in FIG. 3A, above, when an application or any requester (e.g. another enabler, 200) attempts to find a service enabler, it will access directory enabler 270. In one embodiment, the framework instance issues a policy discovery whenever it receives a request for a target enabler. Based on the execution policies of the framework this may involve different steps analogous to accessing another enabler as described in this document.

Once prerequisite services have been satisfied, the find function of directory enabler 270 will return one or multiple target enablers that satisfy the service request. For each target enabler, the associated execution policies will also be retrieved. These returned policies may be passed to the framework instance that manages the exchanges, and may be filtered before being passed to the requestor. Further, additionally policies can be added to the framework to what is returned by the directory (based on the enabler, the requestor, the request or generic considerations).

In the present embodiment, a policy can change after initial discovery and retrieval of the execution policy, as will be described below. As described above, the interfaces, addresses and policies can be obtained in-bane or out-of-band. In such a case the requestor knows what to send and where. Further, the framework intercepts the request as it intercepts all requests to determine the execution policies (e.g. via discovery) and enforce it.

Requestor's Policy and Policy Processing

In one embodiment, after discovery, the discovery enabler forwards the execution policy of a target enabler to the requester. As described above, the execution policy may be filtered before the requester receives it. In response, in the present embodiment, the requestor (or its execution environment (e.g. application-side framework functionality)) compares the execution policies to its own policies.

The requestor's policies may be pre-defined by the execution environment or the user to specify requester preferences. In one embodiment, the requester may perform steps per its own policy to satisfy the execution policy. As an example, the execution policy may specify that a user authentication supporting service must be performed. In such a case, the requester may initiate a user authentication service request with a user-preferred authentication enabler (specified by the requester policy.) As part of the request, the requester composes the service request by providing appropriate user credentials, and the like. In the present embodiment, the requester policy may be defined by the requester to use affiliated enabler services, or the like, or may be defined by the user based upon user-subscriptions, preferences, or the like.

In additional embodiments, the requester policy may include the request for additional services, determining and adding relevant information from previous steps based on the policy information (e.g. user information), adding its own related execution policy information, and the like.

In the present embodiment, the process repeats for each supporting service required by the execution policy. More specifically, the requester issues requests step by step, until the prerequisite services are performed. In this embodiment, because the requester may specify preferred service providers on a step by step basis, this process is termed service request “handholding.”

In this example, policies are controlled by each respective actor and can be updated. For example, the requester policy can be updated by the requester, the execution policy can be updated by the enabler as registered with the directory enabler and with the framework and enforced by enabler node of the framework mechanism when available, and the like. Additionally, policies may be updated by the framework controller (e.g. operator) and updated at the level of the framework nodes (in some deployments) or at the level of the directory. The policies can be introduced via a specific schema (e.g. a declarative document) that binds to the different fields of the interface descriptor; or via an interactive tool that allows a user to visualize/enter/and update the policy and steps that must be satisfied.

In the present embodiment, the directory enabler should store the latest version of the active execution policies; that may result from negotiation. If the execution policy changes, the current request may be re-routed accordingly; possibly with or after update of the requester and agreement.

Request to Target Enabler

In the present embodiment, service requests to the target enabler are typically issued by the requester. The service request is typically composed and complemented with data by the requester. In one embodiment, such data may include information provided by any step previously performed by the requester (e.g. authentication token) or by previous steps or previous services requests, when identified by the requestor as relevant (based on the policy).

In the present example, the target enabler service request is intercepted by the framework mechanism (appropriate instance) and matched against the current active execution policies. As described above, the active execution policy that applies to the request is determined and verified by any framework function by interrogating the directory enabler. In one embodiment, interrogation of a directory enabler may include interrogating additional directory enablers (e.g. a directory proper to the access network provider, etc . . . ). In other cases, the execution policy may be specified differently or is “known” directly by the framework.

In one embodiment, the matching step is in general repeated before each request or routing take place at least to check that no execution policy changes have been made.

In an example such as an authentication step, a location enabler request and authentication step, the authentication enabler may perform the authentication directly if the requestor provided credentials in its request. Further, the framework may return a pointer to an authentication provider to the requester so that it passes its credentials at this stage to it (i.e. if the credentials where not passed with the request). Additionally, the authentication token resulting from a previous authentication step may be checked by the authentication enabler, or other previous interaction with the framework.

In embodiments of the present invention, any enabler (target or supporting base function) can rely on additional enablers and for example an authentication or authorization enabler may support a federation model, such as Liberty or OASIS federation. Whenever needed, the enabler may behave as a requester/application for other enablers, and rely on the same or other instances of the framework.

Technology-Specific Realizations

Technology specific realizations of the overall framework should implement the architecture, mechanisms, flows and specifications to support the framework described in the present document. For mature technologies, a framework is fully defined by the items enumerated above.

For technologies like web services that are not yet fully mature and widely understood as built on a common technology stack; the specification of the framework may also include enumeration or specification of the technologies to support the framework mechanisms (e.g. WS-Security, encryption technologies etc . . . ). In such embodiments, a handholding framework should clarify which available technologies are recommended and how interoperability is achieved. In other embodiments, the framework may wait for availability of the technology components that are missing beyond the support of WS-Execution policies (part of our invention) as discussed above. As such, recommendations may be provided for functionality currently under-specified or ambiguously specified by the Web Service stack, including the specification of execution policies formats: XML, execution policies exchanges and integration with discovery, execution policies negotiation, execution policies enforcement (including dependency on WS choreography), and the like.

FIG. 5 illustrates an embodiment of the present invention. More specifically, FIG. 5 illustrates a deployment configuration according to one embodiment. In this embodiment, the most common deployment configurations associated to this proposal include proxy instances that may be transparently provided by the access network operator (with or without application-side requestor framework or container or enablers).

The embodiment given in FIG. 5, illustrates fully distributed functions between application/requester, enablers, directory and access network provider. In other embodiments, a more web service-centric embodiment, such as Parlay (Corba or Web Service realization) can also be mapped as particular deployment choices of the transparent proxy approach realized in the corresponding technology.

In the present embodiment, the enforcement of enablers can be partially at the application/requestor side, as described above. In other embodiments, an enabler may enforce itself. In other embodiments, enforcement may occur at the execution policy level, by legacy applications that can access the enablers via the framework, by legacy backend applications wrapped with framework compliant interfaces, or the like. The possibility to do this entirely with one or multiple components in the network that intercept all requests; with some requestor-side components that intercept some of the requests, or with components in front of or packaged with, any enabler so that any request to it is intercepted. Any combination of the above can be achieved when all the policy assertions that apply are executed and validated to be successful before a request reaches the target. All of these components can be deployed in the same or different domains. In one embodiment, the last validation step may be performed within a trusted domain before allowing final access to the target enabler.

In the foregoing specification, the invention has been described with reference to specific exemplary embodiments thereof. Many changes or modifications are readily envisioned. For example, frameworks may be implemented as an application or requestor container. Embodiments that may use this may include to add enabler-provider execution policy steps in front or packaged with the enabler that relies on enablers not known to the “main” framework function; for single enablers that do not require a generic framework mechanism; for setup of the system: e.g. initial setup or protection of the directory enabler before any instantiation of the framework; to provide the framework capabilities in environments like WLAN or internet that may not have provided them a priori, or the like.

In another embodiment, request or notifications that originate from an enabler imply change of roles between enablers and requestors in the previous discussions; with the same or a different instance of the framework. Accordingly, requests may be reversed depending upon specific role.

Many types of supported services are contemplated in embodiments of the present invention, such as user authentication functions, user authorization services (including single sign-on), accounting functions (e.g. rates, billing data, charging data), personalization services (e.g. user device identification, application settings and data, user privacy restrictions, usage), session management functions, enabler provisioning, service provisioning, channel management functions, service adaptation to access channel, multiple-device/multi-modal access functions (channel (device, modality) characterization of incoming requests and sessions, multi-device management, system management, administration, and control functions, service registration functions, additional service discovery functions, messaging functions, application level functions (e.g. voice and multimedia routing), Messaging (Push, get) such that enablers will rely upon network specific enablers (e.g. WAP Push, SMS, MMS, and the like), application level voice routing and call control (network specific enablers), application-level multimedia routing and call control (network specific enablers), secure mechanism functions (e.g. trust management functions, secure exchanges, integrity certifications), common naming functions, discovery functions, and the like. It is believed that one of ordinary skill in the art would be able to implement such embodiments in light of the present invention. Delegation to other functions may also involve proprietary enabler deployed in a particular network.

Embodiments of the present invention thus provides a framework that enables service level agreements, identity management, trust management, user mobility and roaming functions. Additional services may include secure data exchanges (e.g. confidentiality, integrity protection, signature /digital certificates), system management (e.g. load balancing, request routing, monitoring, fault detection), system provisioning (e.g. terminal enablers, network enablers, server enablers), and the like. In embodiments of the present invention, combinations of the above supporting services is contemplated.

In embodiments of the present invention, the inventors have determined that advantages of the present schema may be applied to wireless ore teleco deployments. It is also envisioned that the teachings herein may be applied to any distributed services framework. Accordingly, the concepts disclosed above are extremely valuable in a variety of applications. Embodiments may be implemented on virtually any technology or platform, and implemented in a variety of mechanisms, such as declarative (e.g. Web Services), imperative (e.g. procedural, java, CLI), scripted, or the like.

Further embodiments can be envisioned to one of ordinary skill in the art after reading the attached documents. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, deletion of blocks and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A system for enforcing an execution policy associated with a responder comprises:
a framework configured to enforce the execution policy of a target responder in response to a request from a requester, wherein the framework is configured to intercept a request to the target responder, wherein the framework is configured to call at least one supporting function specified by the execution policy, and wherein the framework is configured to pass the request to the target responder after the call to the one supporting function is successful.

2. The system of claim 1 wherein the execution policy of the target responder includes functions requested from the requester.

3. The system of claim 1 wherein the framework is also configured to provide a filtered execution policy to the requester, and wherein the filtered execution policy indicates the one supporting function.

4. The system of claim 3 wherein the framework is also configured to receive a preference for the one supporting finction from the requestor.

5. The system of claim 3
wherein the execution policy specifies another supporting function,
wherein the framework is also configured to provide a filtered execution policy to the requestor,
wherein the filtered execution policy indicates the one supporting function and the other supporting function, and
wherein the requestor calls the other supporting function.

6. The system of claim 1 wherein the framework is also configured to prompt the requestor for input data.

7. The system of claim 1 wherein the framework is also configured to intercept a response from the requestor to the target responder.

8. The system of claim 1 wherein the requestor is selected from the group: enabler, service, application, wireless.

9. The system of claim 8 wherein the requestor is in a domain selected from the group: common domain with the target responder, different domain than the responder.

10. The system of claim 1 wherein the one supporting function is selected from the group: authentication, authorization, charging, logging.

11. A method for a system comprises:
intercepting in a framework, a request to a target responder;
calling from the framework, at least one supporting function specified by an execution policy associated with the target responder;
determining in the framework, whether the one supporting function has successfully completed; and
passing from the framework, the request to the target responder after the one supporting function has successfully completed.

12. The method of claim 11 further comprising the requestor discovering the target responder interface.

13. The method of claim 12 further comprising:
receiving a preference from the requestor for the one supporting function; and
wherein calling at least one supporting function comprises calling the one supporting function in response to the preference.

14. The method of claim 11 wherein the responder interface is passed via side channels.

15. The method of claim 11 further comprising the requestor determining how to formulate the request to the target responder.

16. The method of claim 11 further comprising providing the execution policy to the framework.

17. The method of claim 11 wherein the one supporting function is selected from the group: authentication, authorization, charging, logging.

18. The method of claim 11 wherein the framework comprises a plurality of services and enablers.
